(19) United States
(12) Patent Application Publication
(10) Pub. No.: US 2016/0231427 A1
(43) Pub. Date: Aug. 11, 2016

(54) AUTOMATIC CONNECTION TO GNSS DATA SOURCES

(71) Applicant: AGCO CORPORATION, Hesston, KS (US)

(72) Inventor: Paul Ross Matthews, Marktoberdorf (DE)

(73) Assignee: AGCO Corporation, Hesston, KS (US)

(21) Appl. No.: 14/913,923

(22) PCT Filed: Sep. 3, 2014
(86) PCT No.: PCT/US2014/053844

§ 371 Date: Feb. 23, 2016

Related U.S. Application Data
(60) Provisional application No. 61/872,881, filed on Sep. 3, 2013.
(60) Provisional application No. 61/918,830, filed on Dec. 20, 2013.

(51) Int. Cl. G01S 19/05; G01S 19/07

(52) U.S. Cl. CPC G01S 19/05; G01S 19/07

(57) ABSTRACT

A system for providing information about a plurality of GNSS data sources includes a database for storing information relating to the plurality of GNSS data sources, the database including geographic boundary information and access information associated with each GNSS data source. The system further includes one or more computing devices operative to receive a request for GNSS data source information from a requesting device, wherein the request including a geographic location of the requesting device and, using the database, identify one or more GNSS data sources with geographic boundary information that corresponds to the geographic location of the requesting device. The one or more computing devices are further operable to communicate to the requesting device information relating to the identified one or more GNSS data sources.

### CROSS REFERENCE TO RELATED APPLICATIONS

This application claims the benefit of U.S. Provisional Application Nos. 61/872,881 filed Sep. 3, 2013, and 61/918,830 filed Dec. 20, 2013, both of which are hereby incorporated by reference in their entirety.

### FIELD

Embodiments of the present invention relate to systems and methods of providing global navigation satellite system (GNSS) data to electronic systems or devices associated with, for example, specific machines or vehicles.

### BACKGROUND

Global Navigation Satellite Systems (GNSS) provide geographical positioning information from a plurality of orbiting satellites to receivers around the globe including at sea, on the ground, and in the air. The best known of these systems is the U.S. Global Positioning System (GPS), but other systems, such as the Russian GLONASS system, provide a similar service. They are collectively known as Global Navigation Satellite Systems, and they can provide position accuracies in the range of about 10 meters to about 15 meters. Although the satellites could potentially provide more accurate positions, atmospheric and other effects degrade the quality and reliability of the satellite signals.

Unfortunately, GNSS systems are not sufficiently accurate for all applications. An agricultural machine operating in a field, for example, may require positioning accuracies less than one meter. In order to address this accuracy gap, certain methods and systems may be employed to enhance the accuracy of position-determining systems and devices that use GNSS. Examples of such systems include differential GNSS (DGNSS) and real time kinematic (RTK) satellite navigation systems.

Differential GNSS systems operate on the principle that satellite signals from GNSS systems can be corrected by using one or more reference stations at precisely known locations to distribute correction information to GNSS receivers in the vicinity of the reference stations. Each DGNSS reference station is associated with a stationary GNSS receiver at a precisely known location. Using the location of the GNSS satellites and the location of the stationary receiver, the reference station calculates theoretic or expected travel times between its location and each of the GNSS satellites. By comparing the expected travel times with actual satellite signal measurements, the reference station can identify errors in the received signals as differences between the received and anticipated signals.

Correction information corresponding to the calculated errors is made available to GNSS receivers in the same region as the reference station. The GNSS receivers use the correction information along with the received GNSS satellite signals to determine highly accurate position information. Differential GNSS service is used to enabled precise navigation for marine vessels, ground vehicles and aircraft. Positioning systems that leverage the DGNSS service can have centimeter-level precision, enabling tractors to cross agricultural fields in precisely the same track every time, improving crop yields, and enabling snow plows to operate quickly over roads buried beneath an otherwise trackless snow field.

Differential corrections may be broadcast over radio data links from single reference stations located in precisely known locations, to mobile receivers (rovers) located on vehicles or equipment whose position needs to be determined. As DGNSS services have become more popular and expanded in use, governments and commercial service providers have established networks of reference stations. Such networks may include many reference stations spanning large geographic areas, and one or more computers associated with the network may be configured to estimate correction information for any geographic location within the network's footprint using correction information from one or more of the reference stations. In order to increase the availability and accessibility of DGNSS services, the radio data link may be replaced or supplemented with data streaming over the Internet to devices with Internet connections.

The Networked Transport of RTCM via Internet Protocol, or “NTRIP,” is an example of a protocol that has been developed for streaming GNSS data over the Internet. As indicated in the name, the NTRIP protocol relates to streaming in accordance with specifications published by the Radio Technical Commission for Maritime Services (RTCM), an international standards organization. The NTRIP standard is designed to distribute differential correction data or other types of GNSS data to stationary or mobile users as streaming data over the Internet and is a generic, stateless protocol based on the Hypertext Transfer Protocol. The NTRIP protocol supports wireless Internet access over any mobile IP network including, for example, GSM, GPRS, EDGE, or UMTS.

Various networks that provide GNSS data according to the NTRIP protocol (“NTRIP networks”) are available for public use. Such NTRIP networks may be accessed free of charge, such as networks maintained by a government entity, or may be accessed for a fee. Some NTRIP networks may be very small and localized, based on a single base installation, while others may have a broad geographic scope, such as across an entire state, country or region.

The above section provides background information related to the present disclosure which is not necessarily prior art.

### SUMMARY

A system for providing information about a plurality of GNSS data sources in accordance with a first embodiment of the invention comprises a database for storing information relating to the plurality of GNSS data sources, the database including geographic boundary information and access information associated with each GNSS data source, and one or more computing devices. The one or more computing devices are operative to receive a request for GNSS data source information from a requesting device, the request including a geographic location of the requesting device, and, using the database, identify one or more GNSS data sources with geographic boundary information that corresponds to the geographic location of the requesting device. The one or more computing devices are further operative to communicate to the requesting device information relating to the identified one or more GNSS data sources.

A method in accordance with another embodiment of the invention is performed by one or more computing devices and comprises receiving a request for GNSS data source information from a requesting device, the request including a geographic location of the requesting device, using a database, identifying one or more GNSS data sources with geographic boundary information that corresponds to the geographic location of the requesting device, the database including geographic boundary information and access information associated with each GNSS source, and communicating access information relating to the identified one or more GNSS data sources to the requesting device.

A system for providing information about DGPS networks in accordance with another embodiment of the invention comprises a database for storing information relating to the plurality of DGPS networks, the database including geographic boundary information and access information associated with each DGPS network, and one or more computing devices. The one or more computing devices are operative to receive a request for DGPS network information from a requesting device, the request including a geographic location of the requesting device and conforming to the Internet Protocol, and, using the database, identify one or more DGPS networks with geographic boundary information that corresponds to the geographic location of the requesting device. The one or more computing devices are further operable to communicate to the requesting device information relating to the identified one or more DGPS networks, the information communicated to the requesting device not including DGPS data originating from the one or more DGPS networks.

These and other important aspects of the present invention are described more fully in the detailed description below. The invention is not limited to the particular methods and systems described herein. Other embodiments may be used and/or changes to the described embodiments may be made without departing from the scope of the claims that follow the detailed description.

### DRAWINGS

Embodiments of the present invention are described in detail below with reference to the attached drawing figures, wherein:

FIG. 1 is a schematic diagram of exemplary computing and communications equipment that may be used to implement certain aspects of the present invention.

FIG. 2 illustrates a tractor that may be used with exemplary implementations of the present invention.

FIG. 3 is a schematic diagram of an exemplary electronic system associated with the tractor of FIG. 2 or other mobile machine incorporating principles of the present invention.

FIG. 4 is a schematic diagram of an exemplary operating environment in which embodiments of the present invention may be implemented.

FIG. 5 is a schematic diagram of another exemplary operating environment in which embodiments of the present invention may be implemented.

FIG. 6 is an exemplary data table of a database containing GNSS source information according to embodiments of the present invention.

FIG. 7 is an exemplary data table of a database containing GNSS source information according to embodiments of the present invention.

The drawing figures do not limit the present invention to the specific embodiments disclosed and described herein. The drawings are not necessarily to scale, emphasis instead being placed upon clearly illustrating the principles of the invention.

### DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following description is, therefore, not to be taken in a limiting sense.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

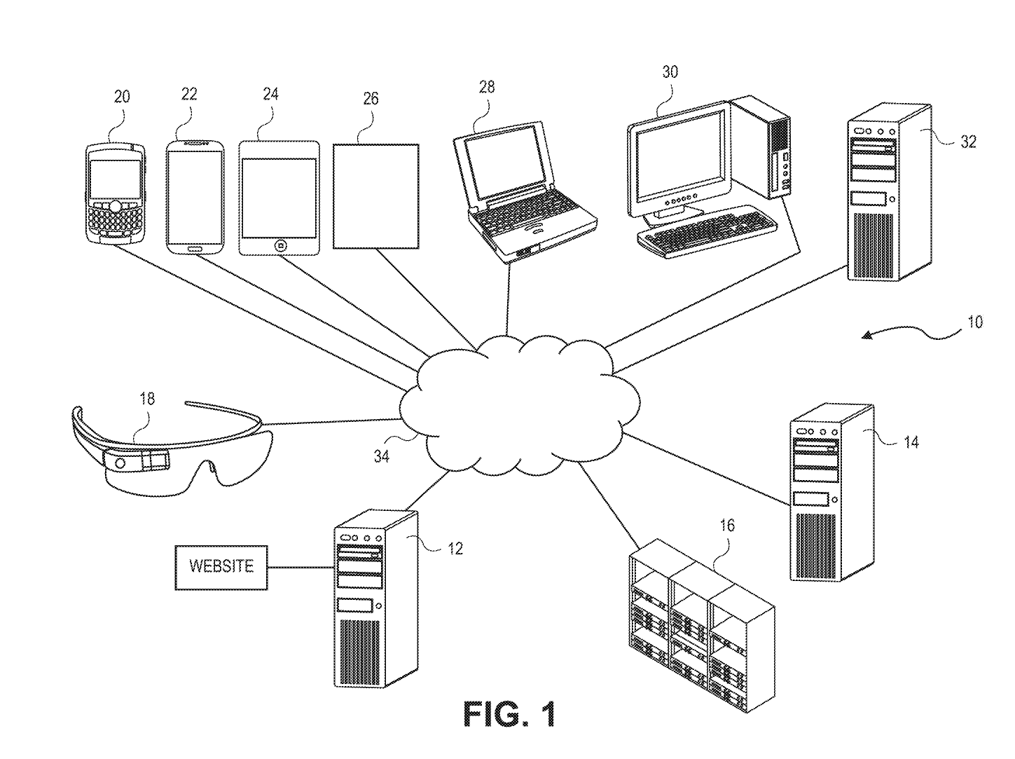

Certain aspects of the present invention can be implemented by, or with the assistance of, computing equipment such as computers and associated devices including data storage devices. Such aspects of the invention may be implemented in hardware, software, firmware, or a combination thereof. In one exemplary embodiment, aspects of the invention are implemented with a computer program or programs that operate computer and communications equipment broadly referred to by the reference numeral 10 in FIG. 1. The exemplary computer and communications equipment 10 may include one or more host computers or systems 12, 14, 16 (hereinafter referred to simply as “host computers”) and a plurality of electronic or computing devices 18, 20, 22, 24, 26, 28, 30, 32 that may access the host computers via a communications network 34. The computer programs and equipment illustrated and described herein are merely examples of programs and equipment that may be used to implement aspects of the invention and may be replaced with other programs and computer equipment without departing from the scope of the invention.

The host computers 12, 14, 16 may serve as repositories for data and programs used to implement certain aspects of the present invention as described in more detail below. The host computers 12, 14, 16 may be any computing and/or data storage devices such as network or server computers and may be connected to a firewall to prevent tampering with information stored on or accessible by the computers.

One of the host computers, such as host computer 12, may be a device that operates or hosts a website accessible by at least some of the devices 18-32. The host computer 12 may include conventional web hosting operating software and an Internet connection, and is assigned a URL and corresponding domain name so that the website hosted thereon can be accessed via the Internet in a conventional manner. One or more of the host computers 12, 14, 16 may host and support a database for storing GNSS information, as explained below. The database may be accessible, for example, via the website operated by the host computer 12.

Although three host computers 12, 14, 16 are described and illustrated herein, embodiments of the invention may use any combination of host computers and/or other computers or equipment. For example, the computer-implemented features and services described herein may be divided between the host computers 12, 14, 16 or may all be implemented with only one of the host computers. Furthermore, the functionality of the host computers 12, 14, 16 may be distributed amongst many different computers in a cloud computing environment.

The electronic devices 18-32 may include various types of devices that can access the host computers 12, 14, 16 via the communications network 34. By way of example, the electronic devices 18-32 may include one or more laptop, personal or network computers 28-32 as well as one or more smart phones, tablet computing devices or other handheld, wearable and/or personal computing devices 18-24. The devices 18-32 may include one or more devices or systems 26 embedded in or otherwise associated with a machine wherein the device or system 26 enables the machine, an operator of the machine, or both to access one or more of the host computers 12, 14, 16. Each of the electronic devices 18-32 may include or be able to access a web browser and a conventional Internet connection such as a wired or wireless data connection. As explained below, the device 26 may be associated with a position determining system or device on a mobile machine and may be operable to communicate with one or more of the host computers 12, 14 or 16 to receive information necessary for the position determining system or device to connect with or otherwise access a GNSS data source.

The communications network 34 preferably is or includes the Internet but may also include other communications networks such as a local area network, a wide area network, a wireless network, or an intranet. The communications network 34 may also be a combination of several networks. For example, the electronic devices 18-32 may wirelessly communicate with a computer or hub in a store via a local area network (e.g., a Wi-Fi network), which in turn communicates with one or more of the host computers 12, 14, 16 via the Internet or other communication network.

One or more computer programs implementing certain aspects of the present invention may be stored in or on computer-readable media residing on or accessible by the computing and communications equipment 10. The one or more computer programs preferably comprise ordered listings of executable instructions for implementing logical functions in the host computers 12, 14, 16 and/or the devices 18-32. The one or more computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

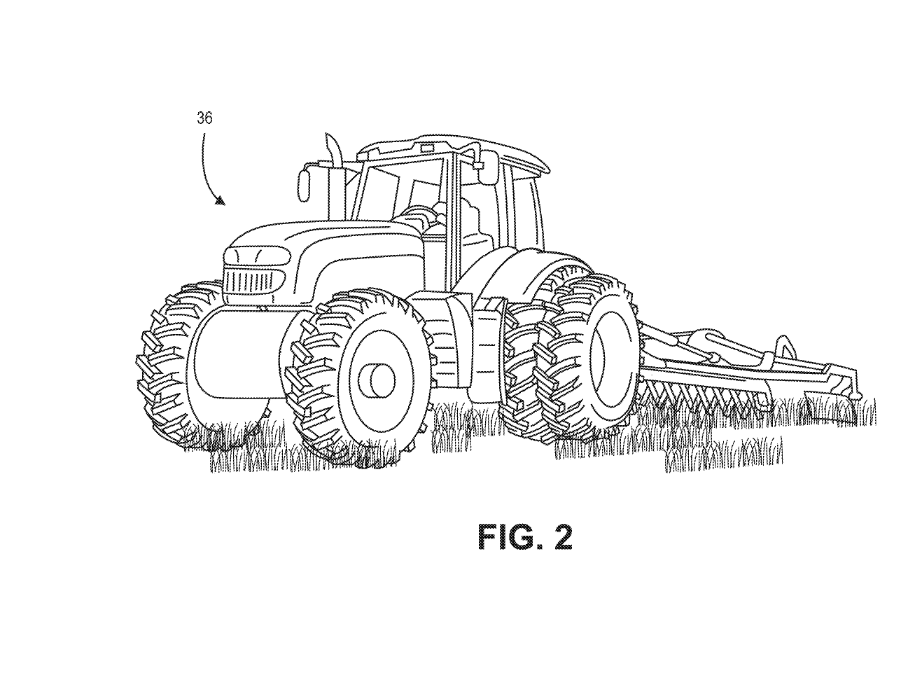

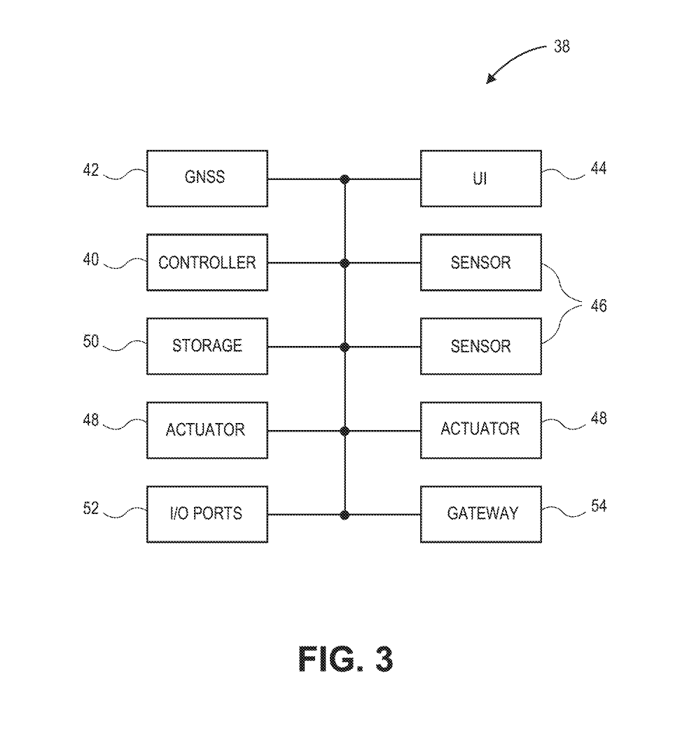

Certain aspects of the present invention can be implemented by or with the assistance of an electronic system, such as a control and communications system associated with a mobile machine. More specifically, aspects of the present invention may be implemented by or with the assistance of an electronic system of a mobile machine used in the agriculture and/or construction industries. Such machines may include tractors (such as, for example, the tractor 36 illustrated in FIG. 2), harvesters, graders or scrapers. Various components of an exemplary electronic system 38 are illustrated in FIG. 3. The system 38 may be or include, for example, an automated guidance system configured to drive the associated machine without operator input. The system 38 broadly includes a controller 40, a position determining device 42, a user interface 44, one or more sensors 46, one or more actuators 48, one or more storage components 50, one or more input/out ports 52 and a gateway 54.

The position determining device 42 may be a global navigation satellite system (GNSS) receiver, such as a device configured to receive signals from one or more positioning systems such as the United States' global positioning system (GPS) and/or the Russian GLONASS system, and to determine a location of the machine using the received signals. The user interface 44 includes components for receiving instructions or other input from a user and may include buttons, switches, dials, and microphones, as well as components for presenting information or data to users, such as displays, light-emitting diodes, audio speakers and so forth. The user interface 44 may include a touchscreen display capable of presenting visual representations of information or data and receiving instructions or input from the user via a single display surface.

The sensors 46 may be associated with any of various components or functions of an associated machine including, for example, various elements of the engine, transmission(s), and hydraulic and electrical systems. The actuators 48 are configured and placed to drive certain functions of the machine including, for example, steering when an automated guidance function is engaged. The actuators 48 may take virtually any form but are generally configured to receive control signals or instructions from the controller 40 (or other component of the system 38) and to generate a mechanical movement or action in response to the control signals or instructions. By way of example, the sensors 46 and actuators 48 may be used in automated steering of the tractor 36 wherein the sensors 46 detect a current position of steered wheels and the actuators 48 drive steering movement of the wheels.

The controller 40 includes one or more integrated circuits programmed or configured to implement the functions described herein. By way of example the controller 40 may be a digital controller and may include one or more general purpose microprocessors or microcontrollers, programmable logic devices, or application specific integrated circuits. The controller 40 may include multiple computing components placed in various different locations on the machine. The controller 40 may also include one or more discrete and/or analog circuit components operating in conjunction with the one or more integrated circuits or computing components. Furthermore, the controller 40 may include or have access to one or more memory elements operable to store executable instructions, data, or both. The storage device 50 stores data and preferably includes a non-volatile storage medium such as optic, magnetic or solid state technology.

It will be appreciated that, for simplicity, certain elements and components of the system 38 have been omitted from the present discussion and from the drawing of FIG. 3. A power source or power connector is also associated with the system 38, for example, but is conventional in nature and, therefore, is not discussed herein.

In one embodiment, all of the components of the system 38 are contained on or in a host machine. The present invention is not so limited, however, and in other embodiments one or more of the components of the system 38 may be external to the machine. In another embodiment, for example, some of the components of the system 38 are contained on or in the machine while other components of the system are contained on or in an implement associated with the machine. In this embodiment, the components associated with the machine and the components associated with the implement may communicate via wired or wireless communications according to a local area network such as, for example, a controller area network. The system 38 may be part of a communications and control system conforming to the ISO 11783 (also referred to as “ISOBUS”) standard. In yet another exemplary embodiment, one or more components of the system 38 may be located remotely from the machine and any implements associated with the machine. In this embodiment, the system 38 may include wireless communications components for enabling the machine to communicate with a remote computer, computer network or system.

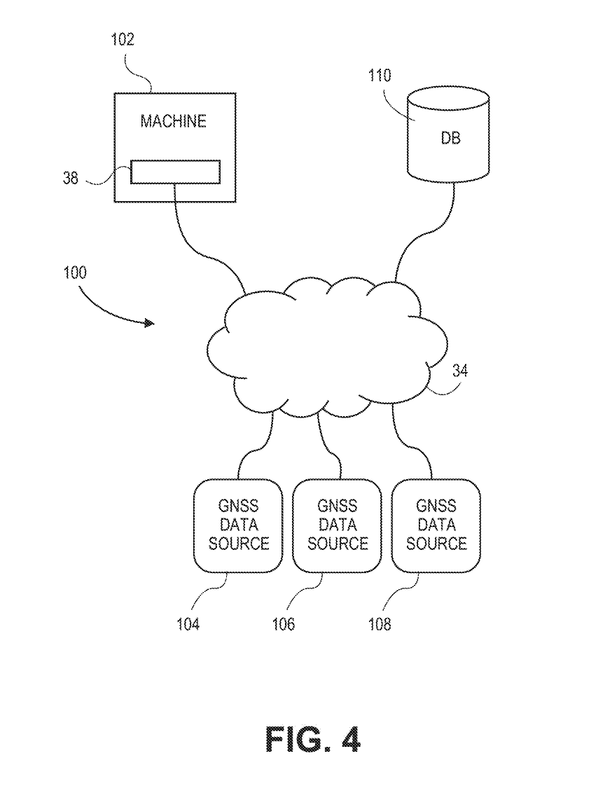

An exemplary operating environment 100 incorporating principles of the present invention is illustrated in FIG. 4. The environment 100 broadly includes a mobile machine 102, a plurality of GNSS data sources 104, 106, 108, a database 110, and the communications network 34. The machine 102 may be a machine used in the agriculture or construction industries, such as a tractor, combine harvester, bulldozer, scraper, grader or the like. The machine may be self-propelled or propelled by another machine, such as in the case of an implement attached to or otherwise associated with a tractor or bulldozer.

The machine 102 includes the electronic system 38 or a similar system configured to perform the functions described herein. It will be appreciated that the particular components, topology and other characteristics of the electronic system 38 may vary from one implementation of the invention to another and that such variations are within the ambit of the present invention. The system 38 is configured to automatically or substantially automatically discover and/or establish communications with one or more of the GNSS data sources 104, 106, 108 with little or no involvement by a machine operator. More specifically, the electronic system 38 is configured to communicate with the database 110 and use information from the database 110 to identify and initiate communications with one or more GNSS data sources that correspond to the machine's geographic location. By way of example, the system 38 may receive GNSS correction information from a GNSS data source, such as differential GNSS or real time kinematic (RTK) information, and use the correction information to correct geographic position information derived from signals detected by the position determining component 42.

In some embodiments of the invention, the position determining device 42 is or includes a GPS receiver for detecting GPS satellite signals and using the signals to determine a location of the machine 102 or for detecting GPS satellite signals and communicating GPS signal information to the controller 40 to enable the controller 40 to determine the location of the machine 102. The gateway 54 enables communications with an external network, as explained above, and may correspond to the component 26 illustrated in FIG. 1. In some embodiments of the invention, the gateway 54 enables data communication with a wireless network, such as a cellular phone network, that forms part of or provides access to the communication network 34, which may include the Internet and/or another computer network. The gateway 54 may include antennas and other hardware and/or software for communicating with the wireless network, as well as control logic for connecting to and communicating over the Internet.

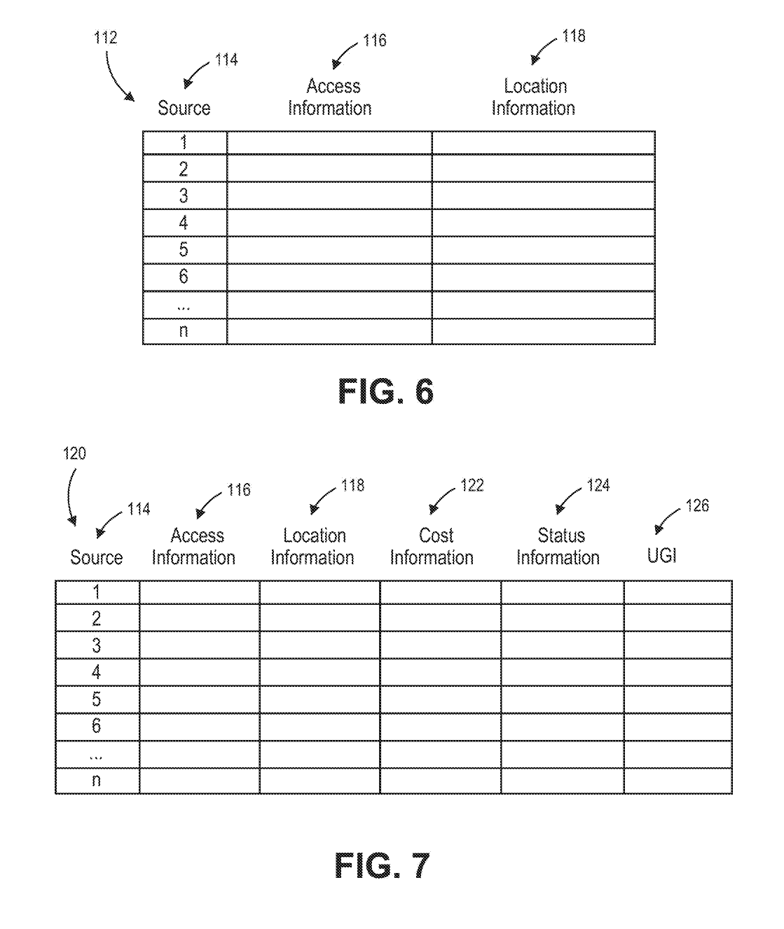

The database 110 includes structured data relating to a plurality of GNSS data sources, such as NTRIP or RTK sources or networks. Such GNSS data source information may include location information and access information associated with each source. An exemplary data table 112 of the database 110 is illustrated in FIG. 6, the table 112 including a source identifier 114, access information 116 and location information 118 associated with each of a plurality of GNSS data sources, including each of the sources 104, 106, 108. Each source identifier 114 may include a name or similar piece of identifying information, although numbers are illustrated in FIGS. 6 and 7 for simplicity. The access information 116 may include a uniform resource locator (“URL”) or IP address, port information and so forth. The location information 118 may be a virtual boundary or “geofence” defining a range or geographic area wherein information from the GNSS data source is reliable, accurate or effective.

The storage component 50 of the system 38 may include user identification information that is unique to the user such as a user name, password, account number, payment information and the like. Alternatively, at least some of the user identification information may be stored in the database 110. The user identification information may be used by the controller 40 to communicate with GNSS data sources that require user-specific identification information, and may be captured by the controller 40 when the operator submits the information for the first time.

In some embodiments, the database 110 is stored on a remote computer or system accessible by the system 38 via the communications network 34. In such embodiments, the system 38 may communicate with the database 110 via the gateway 54. It may be desirable to store the database 110 remotely from the machine 102 to, for example, render it accessible by a large number of machines or devices and to more easily update and maintain the database 110.

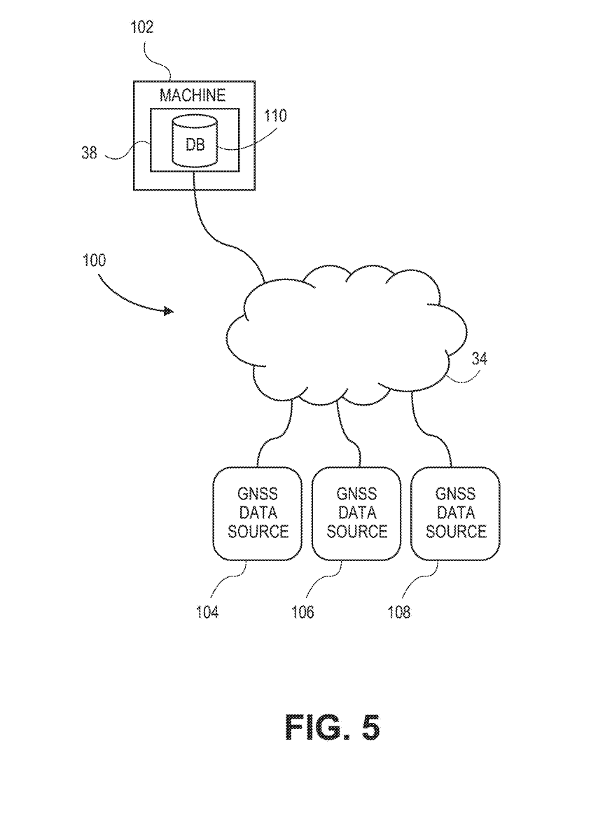

In other embodiments the database 110 is stored on the machine 102, as illustrated in FIG. 5. In these embodiments, the database 110 may be stored in the storage component 50 and/or accessed via the I/O ports 52 and may be an image or copy of a database stored and maintained remotely. The database 110 may be accessed via the I/O ports 52 where, for example, it is stored on a portable storage device such as a solid state drive that is connected to the system 38 via the I/O ports 52. Where the database 110 is stored on the machine 102 it may be automatically or manually refreshed or updated periodically via the communications network 34 or via a storage device accessed via the I/O ports 52. It may be desirable to store the database 110 (or a copy of the database) locally on the machine 102 to, for example, ensure that the database 110 is accessible even if access to the communication network 34 is terminated or unreliable.

The location information 118 in the table 112 relates to the geographic bounds of each of the data sources 104, 106, 108. The geographic bounds of each data source may define, for example, the geographic area in which the data from that source is reliable or useful. If the data source is a DGPS network the geographic bounds associated with the network may be defined by an area within a predetermined distance of reference stations associated with the network where the information from the network is reliable. The geographic bounds may be expressed as one or more circumscribing lines that define a geographic area, or, if the GNSS data source is a single reference station, may be expressed as a point and a distance from the point. Other methods of expressing the location information 118 may be used and are within the ambit of the present invention.

Another exemplary data table 120 is illustrated in FIG. 7. The table 120 includes the source identification information 114, access information 116 and location information 118. The table 120 further includes cost information 122, status information 124 and/or user generated information 126. The system 38 may use the cost information 122, status information 124 and/or user generated information 126 to decide which GNSS data source or sources to use. Alternatively or additionally, the system 38 may present the cost information 122, status information 124 and/or user generated information 126 to a machine operator via a user interface to, for example, assist the machine operator in deciding which of the GNSS data sources 104, 106, 108 to use.

The cost information 122 may include a monetary fee associated with the use of each of the GNSS data sources 104, 106, 108. Some of the sources may be offered at no cost, while others may require a subscription or use fee. Status information 124 relates to the operating status of the GNSS data source including, for example, whether or not the source is active and/or functioning. As explained below, the status information 124 may be generated or collected automatically by a computer program or device associated with the database 110. Alternatively or additionally, the status information may be collected by the computer program when requested by an operator. The user generated information 126 is submitted by users and may relate to the reliability or usability of the GNSS data sources, as explained below.

In addition to the location information 118, the system 38 may use additional information, such as the cost information 122, the source status information 124 and/or the user-generated information 126 to determine which, if any, of the GNSS data sources to use. Determining which of the data sources to use may involve identifying a cost associated with each of the sources and comparing the cost to an expenditure policy, or may involve assessing the status of each of the GNSS data sources to determine which sources are functioning reliably.

Each of the GNSS data sources 104, 106, 108 provides GNSS data for use in connection with a GNSS system. As used herein, “GNSS data” refers to information or data generated by the GNSS data sources and that is not included in the database 110. In some embodiments of the invention, the GNSS data may be supplemental data used to correct or enhance position information derived from GNSS satellite signals. Such supplemental data may include, for example, differential GNSS data or RTK data. The correction data may be time-critical, wherein delays of tenths or hundredths of seconds may degrade the accuracy of the correction information. The GNSS data sources 104, 106, 108 may communicate, for example, via the Internet using the Internet Protocol, such as Networked Transport of RTCM via Internet Protocol (NTRIP). Other protocols may be used, however, and are within the ambit of the present invention.

Different sources may have different access parameters. Some may require a username and password or other account or user identification information, for example, while others may have more open accessibility not requiring sign-in or user identification information. The storage component 50 may store user-specific information such user names and passwords. The database includes the access information associate with each of the sources so that the operator need to remember or look up the access information during operation. The GNSS sources may require a position before generating GNSS information. If the GNSS source is a DGPS network, for example, the correction information generated by the network will depend on the user's position. If the GNSS data source is an NTRIP caster, directly communicating with the source may mean receiving streaming data from the caster over the Internet.

As explained above, each of the GNSS data sources 104, 106, 108 generates and/or communicates GNSS correction information or other GNSS data. In the illustrated embodiment, the table 112 does not include any GNSS data generated by any of the GNSS data sources. Rather, the table 112 includes access information used by the system 38 to communicate with the GNSS data sources 104, 106, 108 and receive the information directly from the sources. In some applications, it may be important or even critical for the system 38 to receive the substantive data or information directly from the GNSS data sources to avoid unnecessary delays in the delivery of the data or information.

In operation, the system 38 uses the database 110 to identify and/or connect to GNSS data sources with little or no involvement by the operator, thereby allowing the operator to focus on other tasks and increasing the likelihood that any available GNSS sources will be discovered and used by the machine. More specifically, the system 38 communicates with the database 110 to identify GNSS data sources corresponding to the machine's geographic location and to acquire access information necessary to enable the machine to connect to one or more of the data sources. The system 38 then connects with or otherwise accesses information from one or more of the GNSS data sources and uses the data from the GNSS data source to, for example, enhance or correct machine position information.

The system 38 may perform the look-up and access completely automatically or may involve the machine operator. The system 34 may communicate with the database to identify a GNSS source and then communicate with that source to receive and use GNSS data, all being performed in the background and without the operator's involvement or even knowledge. Alternatively, the system 38 may collect information about GNSS data sources, present the information to the operator, and prompt the operator to select one or more of the data sources to use. The system 34 may present cost, history, accuracy and/or reliability information for each source. The accuracy and/or reliability information, for example, may originate either from the source owner or from third-party users submitting information, as explained below. The accuracy and/or reliability information would enable the operator to choose a source that meets his or her needs at a cost that is acceptable to the operator.

The system may store information relating to previously-accessed networks and automatically connected to a network only if the operator previously chose to access the network. The operator may select a DGNSS network as a default correction source such that after the operator designates the DGNSS network as the default source, the machine's system automatically connects to it if it is discovered in subsequent operations.

The system 38 may communicate directly with the GNSS source or sources. Communicating directly with a GNSS source may be done via the communication network 34 if the machine establishes a communication session with the GNSS source or an interface to the GNSS source that is required to access the GNSS source. If the GNSS source is an NTRIP source, for example, the machine may directly access the GNSS source by communicating with and/or receiving data from an NTRIP caster associated with the source. Even if GNSS data is communicated through a computer network beyond the control of both the GNSS data source and the machine, the machine receives the GNSS data directly from the GNSS source if the GNSS data comes via a communications session established between the machine and the GNSS data source. Stated differently, the system 38 communicates directly with a GNSS data source if the system does not receive the data from a third party that aggregates and/or repeats data from the data source, if that third part is not a necessary or required part of the communications path.

In one exemplary scenario, the machine is a tractor pulling or carrying an implement used to work a field, such as the tractor 36. Shortly after the operator starts the tractor's engine, the system 38 begins determining the machine's location by acquiring GNSS satellite signals using the position determining component 42 and calculating a position based on the acquired signals. The system 38 then automatically identifies and connects to one or more GNSS data sources that correspond to the machine's location. Specifically, when the system 38 determines the tractor's location using the GNSS signals, it communicates with the database via the gateway 54 and the communication network 34, providing the machine's location to the database 110. One or more controllers or computing devices associated with the database 110 determines which, if any, of the GNSS data sources correspond to the machine's location. The database then retrieves the access information associated with each of those GNSS data sources and communicates that information to the system 38.

Once the system 38 has the access information associated with each of the GNSS data sources, it accesses or communicates with one or more of the data sources to retrieve the GNSS data provided by the source or sources. The system 38 may automatically connect to the GNSS data source or sources, or may present data source information to the operator and prompt the operator to either connect or ignore, as explained above. If the operator elects to connect, the system 38 connects to the one or more GNSS data sources using the GNSS data to correct or enhance the position information derived from the GNSS satellite signals. As the machine operates in a work area, the system 38 continuously determines the machine's position using both the position determining device 42 and data received from the GNSS data source or sources.

The system 38 may use the corrected location information for automated guidance, for monitoring machine performance, for monitoring crop production, or a combination thereof.

According to various embodiments of the invention, one or more user interfaces associated with the database are configured to allow users to view, add, remove and/or manipulate GNSS data source information in the database 110. Such user interfaces may span multiple technology platforms including, for example, an HTML-based web portal and a plurality of dedicated computer programs (sometimes referred to as “apps,” “applications” or simply “software”) running on desktop, portable or hand-held computing devices such as smartphones, tablet computers, laptop computers or the like, or a combination thereof, and configured to communicate with the database 110 via the communications network 34. Thus, one or more user interfaces may be implemented by some or all of the devices 18-24 and 28-32.

Users may view database information via the user interface to determine, for example, which GNSS data sources are available in their area, to confirm the status of one or more GNSS data sources, or to determine if information about a particular known GNSS data source is in the database. Users may submit location information relating to a location of interest, such as particular field or region, wherein the database may present GNSS data source information relevant to that area. Information about GNSS data sources may be presented graphically, such as where the information is presented in map form wherein the boundaries of various GNSS data sources are represented graphically along with the user's location.

In some embodiments of the invention the database receives and includes therein GNSS source information from end users or other third-parties. The user interface receives GNSS source information such as, for example, the name of the source, access information and the location information associated with the source, and stores the information in the database. The third parties may include agricultural producers or other end users who learn of a new GNSS data source and wish to add it to the database for their use, or may be government entities wishing to make information about government-run GNSS data sources more publically available. Allowing third parties to submit information to the database potentially ensures a more exhaustive list of GNSS data sources available via the database and, therefore, increases the likelihood that the system 38 will connect with a GNSS data source.

Information stored in the database may be validated automatically periodically and/or at the request of a user. Software associated with the database may periodically test the GNSS data sources by requesting GNSS data associated with a location corresponding to the GNSS source. The software may communicate with each GNSS source, for example, provide a seed location, and assess the quality of the response, including whether the GNSS source provides the data, the delay between the request and the receipt of the requested data, and the validity of the data itself. Alternatively, status information may be collected from the GNSS data sources. Regardless of how the status and/or reliability information is collected, it may be stored in the database and accessed by the system 34. The system 34 may use the information to determine which GNSS data source to access, or whether or not to access any of the GNSS data sources, as explained above. The system 34 may present the status information to the operator to assist the operator in deciding which GNSS source to use.

While the database 110 and/or one or more user interfaces may be configured to allow third party users to submit new or revised GNSS data source information including the source identifier 114, the access information 116 and the location information 118, as explained above, the user-generated information 126 relates specifically to user experience, such as reliability of particular GNSS sources. Operators may rate the reliability of each source using, for example, a simple numbering system wherein a “1” indicates low reliability and a “5” indicates high reliability. Operators may be prompted to submit the information via a user interface associated with the system 34 and viewable within the machine. Alternatively or additionally, operators may submit reliability information via a user interface presented on a handheld computing device or office computer.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A system for providing information about a plurality of GNSS data sources, the system comprising:
a database for storing information relating to the plurality of GNSS data sources, the database including geographic boundary information and access information associated with each GNSS data source;
one or more computing devices operative to—
receive a request for GNSS data source information from a requesting device, the request including a geographic location of the requesting device,
using the database, identify one or more GNSS data sources with geographic boundary information that corresponds to the geographic location of the requesting device, and
communicate to the requesting device information relating to the identified one or more GNSS data sources.

2. The system as set forth in claim 1, the one or more computing devices further operative to generate a user interface for receiving the request for GNSS data source information from an end user operating the requesting device.

3. The system as set forth in claim 1, the one or more computing devices further operative to—
receive new GNSS data source information from an external device, and
add the new GNSS data source information to the database.

4. The system as set forth in claim 3, the new GNSS data source information including geographic boundary information and access information associated with a GNSS data source that was not previously in the database.

5. The system as set forth in claim 3, the new GNSS data source information including new geographic boundary information or access information associated with a GNSS data source that was previously in the database.

6. The system as set forth in claim 1, the one or more computing devices further operative to automatically confirm the operability of each of the GNSS data sources.

7. The system as set forth in claim 6, the one or more computing devices further operative to update status information of each of the GNSS data sources in the database to indicate an operating status of each source.

8. The system as set forth in claim 1, the system further comprising a user interface for enabling the one or more computing devices to receive GNSS source user experience information from end users.

9. The system as set forth in claim 8, the one or more computing devices further configured to store the user experience information received from the end users in the database.

10. The system as set forth in claim 1, the information relating to the identified one or more GNSS data sources not including GNSS correction information originating from one of the GNSS sources.

11. A method performed by one or more computing devices, the method comprising:
receiving a request for GNSS data source information from a requesting device, the request including a geographic location of the requesting device;
using a database, identifying one or more GNSS data sources with geographic boundary information that corresponds to the geographic location of the requesting device, the database including geographic boundary information and access information associated with each GNSS source; and
communicating access information relating to the identified one or more GNSS data sources to the requesting device.

12. The method as set forth in claim 11, further comprising generating a user interface for receiving the request for GNSS data source information from an end user operating the requesting device.

13. The method as set forth in claim 11, further comprising—
receive new GNSS data source information from an external device, and
add the new GNSS data source information to the database.

14. The method as set forth in claim 13, the new GNSS data source information including geographic boundary information and access information associated with a GNSS data source that was not previously in the database.

15. The method as set forth in claim 13, the new GNSS data source information including new geographic boundary information or access information associated with a GNSS data source that was previously in the database.

16. The method as set forth in claim 11, further comprising automatically confirming the operability of each of the GNSS data sources.

17. The method as set forth in claim 16, further comprising updating status information of each of the GNSS data sources in the database to indicate an operating status of each source.

18. The method as set forth in claim 11, further comprising generating a user interface for receiving GNSS source user experience information from end users.

19. The method as set forth in claim 18, further comprising storing the user experience information received from the end users in the database.

20. The method as set forth in claim 11, the access information communicated to the one or more GNSS data sources not including GNSS correction information originating from one of the GNSS sources.

21. A system for providing information about DGPS networks, the system comprising:
a database for storing information relating to the plurality of DGPS networks, the database including geographic boundary information and access information associated with each DGPS network;
one or more computing devices operative to—
receive a request for DGPS network information from a requesting device, the request including a geographic location of the requesting device and conforming to the Internet Protocol,
using the database, identify one or more DGPS networks with geographic boundary information that corresponds to the geographic location of the requesting device, and
communicate to the requesting device information relating to the identified one or more DGPS networks, the information communicated to the requesting device not including DGPS data originating from the one or more DGPS networks.
